(19) United States
(12) Patent Application Publication
(10) Pub. No.: US 2012/0296834 A1
(43) Pub. Date: Nov. 22, 2012

(54) Systems, Methods and Computer Program Products for a Patent Litigation Entity to Improve Monetization of a Patent Asset

(76) Inventor: Cheryl MILONE, New York, NY (US)

(21) Appl. No.: 13/268,080

(22) Filed: Oct. 7, 2011

Related U.S. Application Data
(60) Provisional application No. 61/486,996, filed on May 17, 2011.

(51) Int. Cl. G06Q 50/18

(52) U.S. Cl. 705/310

(57) ABSTRACT

Systems, methods and computer program products are provided for improved monetization of patents. Patent litigation entities may use these inventions to prevent patent asset evaluators from providing asset evaluation.

### CROSS-REFERENCE TO RELATED APPLICATION

This application claims the benefit of U.S. Provisional Application Ser. No. 61/486,996, filed May 17, 2011. The entire disclosure of that application is incorporated by reference as if set forth fully herein.

### FIELD OF THE INVENTION

The present invention pertains to the field of evaluation of patent assets.

### BACKGROUND OF THE INVENTION

In recent years, there has been an increased appreciation that patents can be valuable assets. As innovators, patent practitioners and savvy investors know, patents can be valuable in two primary ways.

First, a patent holder can use patents to prevent competition. If a patent holder is able to convince a court to enjoin a competitor from selling goods or offering services, the patent holder will have given itself the opportunity to increase market share.

Second, a patent holder can use patents to obtain revenue in exchange for either a covenant not to sue on the subject patent or a license to practice the claimed technology, and to obtain damages for past infringement. The amount that another party and the patent holder agree is a fair value for the right to use technology claimed in a patent is one means by which an invention may be monetized.

Both of the aforementioned values exist because of governmental authorization. However, in order to realize these benefits, a patent holder will need either to come to a private agreement with an allegedly infringing party, or to enforce the patent through litigation.

Perhaps surprising to some people, a patent holder who enforces a patent need not practice the technology claimed within the patent, and the patent holder need not practice a related technology. Thus, the patent holder does not need to be a competitor of the infringer. In fact, the patent holder's business model may in whole or in part be based on acquiring patent rights and licensing those rights to entities that do practice one or more of the technologies in the patent holder's portfolio. Thus, some of theses entities may not practice any technology that offers goods or services directly to the public. As persons of ordinary skill in the art are aware, the prevalence of these entities has been increasing.

Business entities that generate a significant portion if not all of their revenue through licensing and litigation efforts have historically been referred to as non-practicing entities. However, this may be a misnomer. They are in the business of monetizing intellectual property assets through licensing patents under the threat of litigation, and thus are more appropriately referred to “patent litigation entities.”

Many patent litigation entities acquire large numbers of patents and try to enforce them against large numbers of parties that the patent litigation entities contend are infringing entities. The resolution of the disputes between these patent litigation entities and allegedly infringing entities can provide a crude monetized value of the subject patents. The monetization is only crude because enforcement of patents can have high transaction costs and although each patent that issues is presumptively valid, there is always a possibility that one or more claims will subsequently be found invalid, and this uncertainty can distort the fair value of an invention.

At the same time that there has been an increased prevalence of patent litigation entities, there has also been an increased clamoring for improved patent quality. There are two notable efforts in the United States to improve patent quality. The two efforts have been initiated by: (1) Article One Partners, which utilizes crowd-sourcing in order to provide an additional search for prior art against which to measure the novelty and non-obviousness of the claims of an issued patent; and (2) the Peer to Patent Project, which is a joint project between the New York Law School and the United States Patent and Trademark Office (USPTO) that helps the USPTO to find information relevant to assess the novelty and non-obviousness of the claims of pending patent applications. Because both Article One Partners and the unit within New York Law School that operates the Peer to Patent Project evaluate patent assets, they may be referred to as “patent asset evaluators.”

Both of these patent asset evaluators have the potential to improve dramatically the quality of the patent system and from an economist's point of view, both the Peer to Patent Project and Article One Partners help to render the monetization of patents more efficient. For the patent applicant whose claims have been subjected to the Peer to Patent Project, if additional art is uncovered that suggests that there may be a question as to the novelty or non-obviousness of a patent claim, the applicant can amend the claim prior to issuance and thereby have a stronger patent claim. Further, uncertainty over the patentability of the claims over that art can be removed, thereby potentially reducing future litigation costs and allowing for more efficient licensing. For the patent holder whose claims have been the subject of a request for crowd-sourcing review, if additional art is uncovered that raises a question as to the novelty or non-obviousness of an issued claim, the patent holder can file its own request for reexamination in order to remove any doubt with respect to the art, seek reissue and voluntarily offer to narrow the claims in order to avoid the art, or take any uncertainty into account when setting a price for a license to the patent. If the art is collected on behalf of a third party, that third party can similarly request reexamination or take the questionable validity into account when entering into a license for patented technology.

With greater information about patent validity, the price will more accurately reflect the value of the invention that is the subject of the patent. Thus, the existence of patent asset evaluators has the potential to be beneficial to both the public and the patent litigation entity by introducing more efficiency into the patent monetization process.

It is important to note that these benefits inure to society as a whole, but for any one patent that is the subject of a patent evaluation, such as one started by Article One Partners, there is a risk that the results will definitively show that some or all claims are invalid. This will decrease the amount of revenue that the patent holder may be able to generate for that particular patent. However, even these results will make monetization more efficient. The studies produce a dynamic that the patent asset evaluator increases the likelihood that the uncertainty about the validity of the patent will be reduced or eliminated in a finite period of time.

### SUMMARY OF THE INVENTION

In various embodiments, the present invention provides systems, methods and computer program products for protecting against improper valuation of a patent asset. In some embodiments, these inventions are practiced by a patent litigation entity.

According to a first embodiment, the present invention provides a method for reducing the likelihood of evaluation of a patent asset, the method comprising: (a) a practicing litigation entity acquiring a patent that has claims directed to evaluation of a patent asset (including but not limited to using crowdsourcing or a methodology of how the patent asset evaluator evaluates one or more patent claims) and entering information identifying a patent asset evaluator into a data storage unit, wherein the practicing litigation entity derives at least a portion of its revenue from licensing patent rights that cover technologies that the practicing litigation entity does not practice; (b) the practicing litigation entity causing a metric to be associated with the information identifying the patent asset evaluator in the data storage unit, wherein the metric concerns at least one of: (i) identification of the patent evaluator in association with data related to at least a portion of the patent evaluator's business that involves evaluating patents; (ii) identification of the patent evaluator in relation to the patent evaluator being a party to a lawsuit; (iii) identification of a public platform where patents are evaluated; (iv) a recommendation of whether the patent litigation entity should sue said patent evaluator; or (v) a relative ranking of the benefits of the patent litigation entity suing the patent evaluator; and (c) the practicing litigation entity causing to be filed a complaint against the patent asset evaluator, wherein the complaint is filed in a tribunal in which the filings are monitored by at least one database service that updates its records based on the filings.

According to a second embodiment, the present invention provides a system for increasing the value of a patent litigation entity comprising: (a) a data storage unit; and (b) a computer that is configured (i) to receive information sufficient to identify a patent asset evaluator and to store the information sufficient to identify the patent asset evaluator in the data storage unit, (ii) to associate a metric with the information sufficient to identify the patent asset evaluator, and (iii) to store the metric in the data storage unit, wherein the metric concerns at least one of a recommendation of whether the patent litigation entity should sue the patent evaluator or a relative ranking of the benefits of the patent litigation entity suing the patent evaluator, wherein the patent litigation entity derives at least a portion of its revenue from licensing patent rights that cover technologies that it does not practice.

### DETAILED DESCRIPTION OF THE INVENTION

According to one embodiment, the present invention provides a method for protecting against undesirable evaluation of a patent. An “undesirable evaluation” includes any evaluation of a patent that a party wishes to discourage or to prevent, and includes an evaluation that adds risk to the patent litigation entity's business model. Additionally, the method may be used to protect against the evaluation of any and all patents by the patent asset evaluator, regardless of ownership or technology.

The method comprises acquiring at least one patent asset and suing a patent asset evaluator thereby discouraging or preventing the patent asset evaluator from evaluating the asset or assets of the party suing the patent asset evaluator. The patent may for example be acquired by a practicing litigation entity. The practicing litigation entity may acquire a plurality of patents, e.g., at least 2, at least 10, at least 25, at least 50, at least 100, at least 250, at least 500, at least 1000, etc.

In some embodiments, a practicing litigation entity derives at least a portion of its revenue from licensing patent rights that cover technologies that the practicing litigation entity does not practice and may never have practiced. Thus, it may not have sponsored or employed the inventors who invented the claimed invention or inventions. In some embodiments, at least 5%, at least 10%, at least 25%, 40%, at least 50%, at least 60%, at least 70, at least 80%, at least 90%, at least 95% or 100% of the practicing litigation entity's revenue is derived from licensing patent rights that cover technologies that the practicing litigation entity does not practice. The phrase “substantially all of the revenue” refers to conditions in which at least 67% of the revenue is generated from recited sources. Unless otherwise specified, revenue may be considered to be derived from licensing patent rights if money is paid in exchange for either a covenant not to be sued under a patent or a license to practice the technology of a patent. The revenue may be paid directly to the patent litigation entity or it may be paid to another entity for the benefit of the patent licensing entity or pursuant to an agreement into which the practicing licensing entity has entered.

The practicing litigation entity may acquire a plurality of patent assets (e.g., a patent or patent application), and one or more of those assets may have one or more claims directed to evaluation of a patent asset. The practicing litigation entity may acquire the rights by, for example, purchase and assignment from an inventor or other entity that owns the patent. Alternatively, it may become an exclusive licensee with the right to sublicense the technology of the patent. In some embodiments, only a small percentage of the practicing litigation entity's patents contain claims directed to the activities of or technologies designed for a patent asset evaluator, for example, only one patent or only one patent family or only one to five such patents or only one to five such patent families. This may for example represent less than 5% or less than 2% or less than 1% or less than 0.1% of the patent litigation entity's patent portfolio.

The methods for identifying an asset for acquisition include but are not limited to being approached by the patent holder from whom the practicing litigation entity will acquire it, as well as monitoring government sponsored publications in either print or electronic form for newly issued patents, as well as monitoring the popular press and trade publications for what the market has determined are or may be of significant commercial value. Still further methods for identifying patents for acquisition include those described in U.S. patent application Ser. No. 13/098,883, filed May 2, 2011, the disclosure of which is incorporated by reference in its entirety. According to one of those methods, there may be a method for identifying a patent of potential value, by: (a) identifying a patent dispute in which an assertion of at least one of infringement, unenforceability or invalidity of a first patent has been made; and (b) identifying a second patent that satisfies at least one of the following conditions: (i) is identified on the face of said first patent; (ii) is a family member of a patent or patent application that is identified on the face of said first patent; (iii) is referenced in the file history of said first patent; (iv) is a family member of a patent or patent application that is referenced in the file history of said first patent; (v) is identified in a prior art search conducted against at least one claim of said first patent; (vi) is a family member of a patent or patent application that is identified in a prior art search conducted against at least one claim of said first patent; (vii) is cited in a document produced or generated in said patent dispute; (viii) is a family member of a patent or patent application that is cited in a document produced or generated in said patent dispute; (ix) is identified in a technology description of all or a part of a claim or embodiment of the first patent or in a technology description of all or part of an alleged infringing system or method; (x) is a family member of a patent or patent application that is identified in a technology description of all or a part of a claim or embodiment of the first patent or in a technology description of all or part of an alleged infringing system or method; or (xi) has as at least one named inventor, a person who is named as an author of a non-patent reference that is cited on the face of the first patent, is referenced in the file history of the first patent, is identified in a prior art search conducted against at least one claim of the first patent, is cited in a document produced, referenced or generated in the patent dispute or is identified in said technology description.

A second method described in U.S. application Ser. No. 13/098,833 that may be used in connection with the present invention provides: (a) identifying a patent dispute in which an assertion of at least one of infringement, unenforceability or invalidity of a first patent has been made; (b) identifying a second patent that satisfies at least one of the following conditions: (i) is identified on the face of the first patent; (ii) is a family member of a patent or patent application that is identified on the face of the first patent; (iii) is referenced in the file history of the first patent; (iv) is a family member of a patent or patent application that is referenced in the file history of the first patent; (v) is identified in a prior art search conducted against at least one claim of the first patent; (vi) is a family member of a patent or patent application that is identified in a prior art search conducted against at least one claim of the first patent; (vii) is cited in a document produced or generated in the patent dispute; (viii) is a family member of a patent or patent application that is cited in a document produced or generated in the patent dispute; (ix) is identified in a technology description of all or, a part of a claim or embodiment of the first patent or in a technology description of all or part of an alleged infringing system or method; (x) is a family member of a patent or patent application that is identified in a technology description of all or a part of a claim or embodiment of the first patent or in a technology description of all or part of an alleged infringing system or method; or (xi) has as at least one named inventor, a person who is named as an author of a non-patent reference that is cited on the face of the first patent, is referenced in the file history of the first patent, is identified in a prior art search conducted against at least one claim of the first patent, is cited in a document produced, referenced or generated in the patent dispute or is identified in said technology description; and (c) identifying a third patent that satisfies at least one of the following conditions (i) is identified on the face of the second patent; (ii) is a family member of a patent or patent application that is identified on the face of the second patent; (iii) is referenced in the file history of the second patent; (iv) is a family member of a patent or patent application that is referenced in the file history of the second patent; or (v) has as at least one named inventor, a person who is a named author of a non-patent reference that is cited on the face of the second patent, or is referenced in the file history of the second patent. Under either of these methods, the patent litigation entity may then purchase or license the desired patent or provide information that identifies the desired patent to an agent, wherein after receiving said information, the agent purchases or licenses the third patent for the patent litigation entity.

As noted above, in some embodiments, at least one of the patent assets that the practicing litigation entity acquires may have one more claims directed to the evaluation of a patent. By way of a non-limiting example, the claims may include one or more, if not all of the following features: (i) a step for obtaining prior art references; (ii) a step for organizing prior art references; (iii) a step for applying prior art references to one or more patent claims; (iv) a computer program product that applies any of (i)-(iii); (v) a data storage unit configured to store data associated with any of (i)-(iii); (vi) a computer configured to implement any of (i)-(iii); and (vii) a system that incorporates or applies any of (i)-(v). Furthermore, if the patent litigation entity has this type of patent in its portfolio, it may have acquired it from another entity or on its own behalf, filed the application that led to its issuance or employed directly the named inventor or inventors on such patent.

The practicing litigation entity may then cause to be filed a complaint against a patent asset evaluator. In some embodiments, the complaint alleges one or more of patent infringement, antitrust violations and unfair competition. Thus, the methods of the present invention may be used by a patent litigation entity regardless of whether it owns or has rights to a patent that is directed to the activities of or technologies used by a patent asset evaluator. The complaint may be filed in a tribunal in which the filings are monitored by at least one database service that updates its records based on the filings, such at Pacer®. In some embodiments, the complaint comprises a request for injunctive relief, such as one or more if not all of a temporary restraining order, a preliminary injunction and permanent injunction.

The tribunal may be selected so that it is obligated to send notice to a government patent office of any filing of a complaint for patent infringement. For example, in the United States the tribunal may be a United States District Court and in other jurisdictions, it may be a court or administrative tribunal authorized to entertain such actions in those jurisdictions. Preferably, the government patent office is obligated to update its publically available records after receipt of the notice. The notice may be sent electronically and/or by regular mail, and may, for example, be accessible over the internet as in the case of the PAIR system in the United States. Thus, the database of the government will be updated and thereby transformed.

Optionally, the practicing litigation entity also may enter patent information into a data storage unit that identifies the patent asset or patent assets that it acquires. The identification may for example include one or more of bibliographic information, a PDF of the patent, a text version of the patent or subset of it such as the claims, data about the chain of title, the file wrapper, and a link to any of the aforementioned information.

The practicing litigation entity may also cause a metric to be associated with the information about the patent asset evaluator in the data storage unit. The metric may concern at least one of: (i) identification of the patent evaluator in association with data related to at least a portion of the patent evaluator's business that involves evaluating patents (e.g., by percentage of business, volume of business or binary condition of any business is that field); (ii) identification of the patent evaluator in relation to the patent evaluator being a party to a lawsuit (e.g., number of lawsuits, number of patent lawsuits, or binary condition of being a party to any lawsuits or any patent lawsuits); (iii) identification of a public platform where patents are evaluated (e.g., duration of platform's being in existence, number of hits per unit time, number of total hits, or binary condition of being on a public platform); (iv) a recommendation of whether the patent litigation entity should sue said patent evaluator (e.g., a determination of the likelihood of prevailing and/or economic benefit of prevailing); or (v) a relative ranking of the benefits of the patent litigation entity suing the patent evaluator (e.g., a comparison of benefits of suing one patent asset evaluator as opposed to suing another patent asset evaluator). For example the metric may be based on combination of any one, two, three, or four or all five of the above-referenced pieces of information, and the metric may e.g., consider binary conditions for each or any of the variable conditions or it may take into account the relative importance of the variable. Thus, by way of a non-limiting example, with respect to variable (ii) if the patent asset evaluator is party to any lawsuit regardless of the number of lawsuits, the metric may be increased by the same amount, or alternative, the metric may be greater when the patent asset evaluator is a party to multiple lawsuits.

The metric may for example be obtained by receiving input from a user of the method or other source. By way of a non-limiting example, the metric may be a scale of 1 to 5, with 5 being the highest recommendation for taking action with respect to the particular patent asset evaluator.

When a patent litigation entity is considering suing a patent asset evaluator under a claim of patent infringement the metric may reflect the value of a patent to be used as a tool in general and thus, reflect an appreciation of its scope and/or validity. The metric may also be patent asset evaluator specific and thus, include a consideration of likelihood of success of a claim of patent infringement. When the metric falls into account a likelihood of proving infringement, and the value of the asset with respect to scope and validity, the metric may have two variables, x, y, with x being a variable that reflects the scope and validity, and y reflecting a likelihood of prevailing on a claim of infringement. Both may be based on a scale of 1 to 5. When more than one variable is taken into account, in some embodiments, the metric may be defined as a composite piece of information while in other circumstances it may be represented by a multi-variable vector.

In some embodiments, prior to filing of a complaint, simultaneously with filing a complaint, or after filing of a complaint, the practicing litigation entity records an assignment with a governmental body that notes that rights to the patent have been assigned to the practicing litigation entity. Preferably, the assignment is recorded with a governmental body that is obligated to update its records to provide public notice of the assignment.

Practicing litigation entities are aware that they may acquire rights to patent, e.g., by assignment after a patent issues. However, a practicing litigation entity may also acquire rights prior to issuance, i.e., when the invention is the subject of a patent application that is pending. Furthermore, many patent applications and patents are part of a patent family that includes one or more continuation, divisional, continuation-in-part, foreign, provisional and reissue applications. A practicing litigation entity may simultaneously acquire rights to one or more family member applications or limit acquisition to certain family members or to only one patent or application or limit acquisition by jurisdiction.

Patent litigation entities may also control the timing of when they file a complaint against a patent asset evaluator. For example, the patent litigation entity may file the complaint within one day, one week, one month, two months, three months, four months, five month, six months, nine months or one year of issuance of the patent or acquisition of the patent, or it may chose to file the complaint after one day, one week, one month, two months, three months, four months, five months, six months, nine months or one year of issuance of the patent.

As persons of ordinary skill in the art are aware, in some jurisdictions such as in Europe a third party may file an opposition to a patent within a fixed time after issuance, e.g., nine months. In these jurisdictions, the patent litigation entity may elect to file the complaint after the expiration of this period, e.g., within one week or one month of completion of any government prescribed opposition period for the patent.

According to another embodiment the present invention provides a system for increasing the value of a patent litigation entity. The system comprises: a data storage unit, and a computer. The computer is configured to receive information sufficient to identify a patent asset evaluator and to store the information sufficient to identify the patent asset evaluator in the data storage unit, and to associate a metric with the information sufficient to identify the patent asset evaluator, and to store the metric in the data storage unit, wherein the metric concerns at least one of a recommendation of whether the patent litigation entity should sue the patent evaluator or a relative ranking of the benefits of the patent litigation entity suing the patent evaluator, wherein the patent litigation entity derives at least a portion of its revenue from licensing patent rights that cover technologies that it does not practice. In other embodiments, the metric may be based on any one or more of the variables described in this specification.

In some embodiments, the computer is further configured to apply an algorithm to generate the metric. The algorithm may be designed to request input data or it may collect the data automatically by mining a database that contains the requisite information or crawling the internet or other networks to obtain the data. By way of non-limiting examples, the algorithm may comprise at least one variable selected from the group consisting of the patent asset evaluator's time in business; the patent asset evaluator's experience in evaluating patents; the relative amount of the patent asset evaluator's experience in evaluating patents owned by practicing legal entities as compared to the total number of patents examined by the patent asset evaluator; whether a reexamination is pending against the practicing litigation entity; and whether a request for reexamination has ever been filed against the patent litigation entity by the patent evaluator. In some embodiment, the algorithm comprises at least two of the aforementioned variables. For example an algorithm, can be use wherein:

a=number of years that the patent asset evaluator is in business.

b=number of patents that the patent asset evaluator has evaluated.

c=the ratio of the number of patents examined by the patent evaluator that are owned by a practicing litigation entity to the total number of patents examined by the patent asset evaluator.

d=1 if no reexaminations are pending against the practicing litigation entity or equals the total number of reexaminations pending against the practicing litigation entity.

e=1 if no reexaminations have be filed against the patent litigation entity by the patent asset evaluator or if any reexaminations have been filed against the patent litigation entity, by the patent asset evaluator, then the total number of those reexaminations.

The value of the Metric may be defined as=b/a+(c * d * e).

When multiple variables are contained, they may each be unweighted or they may contain variable weights depending on the variables that the practicing litigation entity wishes to have considered and the relative importance of the variables.

The system may be designed to facilitate the practicing litigation entity's use of form complaints that allow for the automatic or manual insertion of one or more of the tribunal, defendants, and patent number. These complaints may, after the computer receives the requisite instructions, automatically generate the complaint for attorney review. The system may also be configured such that it is able to communicate through a network to an electronic filing system and allow for filing of pleadings.

The system may also be designed such that the computer is configured to send notice to the patent asset evaluator of a complaint being filed against the patent asset evaluator. Alternatively or additionally, notice of the filing of the complaint may be sent to other parties and/or posted on a website maintained by or under the control of the patent litigation entity.

The system may also contain one or more of an output device, wherein the output device is capable of displaying the recommendation or ranking on a graphic user interface; a graphic user interface; and an input device. Any or all of such devices may be operably coupled to the computer and/or database.

The systems, methods and computer program products of the various embodiments of the present invention may be implemented through technologies that are now known or that come to be known and that may be appreciated by persons of ordinary skill in the art as being of use in connection with the present invention. For example, the instructions for implementing the above-referenced methods may be embodied in a computer program product and carried out on hardware, software or a combination thereof that permits the development and use of systems that comprise components that are operably coupled to one another.

The various embodiments of the present invention may be performed by one or more computers that have access to networks or communication devices in order to permit them to access and to interact with the necessary information sources. Thus, in various embodiments, the methods are accomplished through the use of a computer that comprises a central processing unit and one or more input/output devices.

The systems, methods and computer program products may be implemented through one or more computers or central processing units that are configured to automate the methods of the present invention. The phrase “central processing unit” and the abbreviation “CPU” are used interchangeably and refer to an electronic circuit that can execute a computer program and can accomplish electronic communication through for example a processor. A processor is the part of a computer that can execute instructions and manipulate data. The phrase “computer program product” as used herein, refers to instructions that can be stored on hardware, software or a combination of both.

The system may have specific software, including a browser that standardizes communication with network servers. These servers may be any devices that are capable of receiving, delivering and sending email messages, text messages and/or other messages that are sent to it. Thus, a server may comprise a storage device, an input device, an output device, a memory device, a processor and a communication interface.

Persons who are interested in utilizing the methods, systems and computer products of the present invention may communicate with the entity (that may be referred to as a provider) or computer that implements the methods through one or more input devices, output devices, and communication interfaces. An input device is any device that may be used to input, to select and/or to manipulate information. By way of example, input devices include, but are not limited to, a keyboard, a mouse, a graphic tablet, a joystick, a light pen, a microphone, a smart phone and a scanner. An output device may be any device that enables a computer to present information to a user, and includes, but is not limited to, a video display, a printer, and an audio speaker.

A communication interface is a tool for receiving input and sending output. Thus, it is or is part of a portal or is operably coupled to a portal. By way of example, communication interfaces may include but are not limited to a modem, network interface card and requisite software such as for protocol conversion and data conversion to communicate through e.g., a LAN, WAN or otherwise over the Internet. A “portal” is a method, system or apparatus for connecting to a network. For example, a portal may be a means of accessing the Internet.

The aforementioned data storage unit may be stored on or in the form of one or more memory devices. A memory device is a device that can store, retrieve or facilitate the retrieval of data. By way of example, a memory device may comprise one or more of Random Access Memory (RAM), Read Only Memory (ROM), a magnetic drive, a Digital Video Disk (DVD) drive, or removable media storage. This information may, for example, be stored in a database.

In another embodiment, the present invention provides a computer program product stored in a tangible medium. The medium may be a non-transitory tangible computer readable storage medium comprising a set of executable instructions that are capable of directing a computer to execute the necessary steps for the modules that implement the invention to perform their intended purpose or to effectuate any of the methods described herein.

A “non-transitory tangible computer readable storage medium” may also be referred to as a computer program product, and includes hardware, software or a combination of the two on which one may store a set of instructions that may be used to direct a computer to perform a set of steps. Examples of non-transitory tangible computer readable storage medium include, but are not limited to, a hard drive, a hard disk, a floppy disk, a thumb drive, a computer tape, ROM, EEPROM, nonvolatile RAM, CD-ROM and a punch card. Thus, in some embodiments the instructions are software stored on a medium that can instruct a computer having one or more of the following hardware components: memory, storage, an input device, an output device and a central processing unit.

Unless otherwise specified, any of the features of the various embodiments described herein can be used in conjunction with features described in connection with any other embodiments disclosed. Accordingly, features described in connection with the various or specific embodiments are not to be construed as not suitable in connection with other embodiments disclosed herein unless such exclusivity is explicitly stated or implicit from the context.

1-20. (canceled)

21. A method of determining a metric of whether a patent owner should file a complaint for patent infringement against a potential infringer, the method comprising the steps of:
determining, by one or more processors, via one or more databases, at least one input selected from the list comprising of the potential infringer's number of years in business, a total number of patents that the potential infringer evaluated, the number of patents that the potential infringer evaluated that were owned by practicing litigation entities as compared to the total number of patents that the potential infringer evaluated, whether a reexamination is pending against the patent owner, and whether a request for reexamination has ever been filed against the patent owner by a patent evaluator;
receiving, by the one or more processors, the at least one input;
determining, by the one or more processors, using the at least one input, the metric of whether to file a complaint for patent infringement against a potential infringer;
storing the metric in a memory;
determining, by the one or more processors, using the metric, a recommendation of whether to file a complaint; and
displaying a recommendation of whether to file a complaint, for infringement of a patent, against the potential infringer.

22. The method of claim 21, wherein said complaint contains a request for injunctive relief.

23. The method of claim 21, wherein said complaint contains allegations of infringement of the patent that has claims directed to the activities of or technologies used by the patent evaluator.

24. The method of claim 23, wherein a court that receives the complaint is obligated to send notice to a government patent office of any filing of a complaint for patent infringement.

25. The method of claim 24, wherein the government patent office is obligated to update its publically available records after receipt of said notice.

26. The method of claim 23, wherein the patent owner records an assignment with a. governmental body that notes that rights to the patent have been assigned to the patent owner.

27. The method of claim 26, wherein the governmental body is obligated to update its records to provide public notice of said assignment.

28. The method of claim 23, where said patent litigation entity acquires rights to a patent application that will issue as said patent.

29. The method of claim 23 further comprising the patent owner acquiring rights to family member patents or patent applications.

30. The method of claim 21, wherein patent licensing comprises substantially all of said patent owner's revenue.

31. The method of claim 21 further comprising automatically generating, via the one or more processors, a complaint for patent infringement.

32. The method of claim 21, wherein the metric is defined as=b/a+(c * d * e), where
a=number of years that the patent asset evaluator is in business;
b=number of patents that the patent asset evaluator has evaluated;
c=the ratio of the number of patents examined by the patent evaluator that are owned by a practicing litigation entity to the total number of patents examined by the patent asset evaluator;
d=1 if no reexaminations are pending against the practicing litigation entity or equals the total number of reexaminations pending against the practicing litigation entity; and
e=1 if no reexaminations have be filed against the patent litigation entity by the patent asset evaluator or if any reexaminations have been filed against the patent litigation entity, by the patent asset evaluator, then the total number of those reexaminations.

34. The method of claim 21, wherein determining, by the one or more processors, the metric further comprises determining a composite of the inputs.

35. The method of claim 21, wherein determining, by the one or more processors, the metric further comprises determining, using two or more inputs, a multi-variable vector.

36. The method of claim 21, wherein determining, by the one or more processors, the metric comprises two variables.

37. A non-transitory computer-readable storage medium storing instructions which, when executed by a computing device, cause the computing device to determine a metric of whether a patent owner should file a complaint for patent infringement against a potential infringer, the instructions comprising:
determining, via one or more databases, at least one input selected from the list comprising of the potential infringer's number of years in business, a total number of patents that the potential infringer evaluated, the number of patents that the potential infringer evaluated that were owned by practicing litigation entities as compared to the total number of patents that the potential infringer evaluated, whether a reexamination is pending against the patent owner, and whether a request for reexamination has ever been filed against the patent owner by a patent evaluator;
receiving the at least one input;
determining using the at least one input, the metric of whether to file a complaint for patent infringement against a potential infringer;
storing the metric in a memory;
determining using the metric, a recommendation of whether to file a complaint; and
displaying a recommendation of whether to file a complaint, for infringement of a patent, against the potential infringer.

38. The non-transitory computer-readable storage medium storing instructions of claim 37, wherein determining the metric further comprises determining a composite of the inputs.

39. The non-transitory computer-readable storage medium storing instructions of claim 37, wherein determining the metric further comprises determining, using two or more inputs, a multi-variable vector.

40. A method of determining a metric of whether a patent owner should file a complaint for patent infringement against a potential infringer comprising:
receiving, via one or more processors, one or more inputs reflecting one or more of the potential infringer's number of years in business, a total number of patents that the potential infringer evaluated, the number of patents that the potential infringer evaluated that were owned by practicing litigation entities as compared to the total number of patents that the potential infringer evaluated, whether a reexamination is pending against the patent owner, and whether a request for reexamination has ever been filed against the patent owner by a patent evaluator;
normalizing, via the one or more processors, the values for input to an algorithm for generating a metric;
generating, via the one or more processors, the metric representative of whether to file a complaint for patent infringement against a potential infringer; and
indicating, via a graphical user interface and the one or more processors, whether to file a complaint, for infringement of a patent, against the potential infringer.
